(19) United States
(12) Patent Application Publication
(10) Pub. No.: US 2009/0294536 A1
(43) Pub. Date: Dec. 3, 2009

(54) Monetary card reading machine, advertisement information management system, and receipt-printing method

(75) Inventor: Hua-Wen Chia, Taipei (TW)

Correspondence Address: BACON & THOMAS, PLLC, 625 SLATERS LANE, FOURTH FLOOR, ALEXANDRIA, VA, 22314-1176, US

(73) Assignee: AIRLINK TECHNOLOGY CO., LTD., Taipei (TW)

(21) Appl. No.: 12/314,157

(22) Filed: Dec. 5, 2008

(30) Foreign Application Priority Data
May 28, 2008 (TW) 097119610

(51) Int. Cl. G06K 7/08

(52) U.S. Cl. 235/449

(57) ABSTRACT

A monetary card reading machine capable of printing an advertisement information on a receipt is disclosed. The monetary card reading machine comprises a memory comprising a software program and at least one advertisement information; a processor electrically connected to the memory, the processor being able to execute the software program; and a print module electrically connected to the processor. The print module prints at least one advertisement information on the receipt by executing the program.

### BACKGROUND OF THE INVENTION

1. Field of the Invention

The present invention relates to a monetary card reading machine, an advertisement information management system, and a receipt printing method.

2. Description of the Related Art

Traditionally there are cashier machines capable of providing advertisement information to consumers in the prior art, wherein these cashier machine print advertisement information on a flyer; however, the prior art cashier machines are usually based on personal computers, which require higher cost and more installation space than common cashier machines.

In addition, although prior art monetary card reading machines can print advertisement information on receipts, these monetary card reading machines usually print the same advertisement information during a certain period of time, or these monetary card reading machines randomly and circularly generate advertisement information; however, these printed advertisement informations are not generated based on the target consumers and fail to attract consumers.

Therefore, it is necessary to provide a monetary card reading machine, an advertisement information management system, and a receipt printing method to overcome the deficiencies of prior art monetary card reading machines.

### SUMMARY OF THE INVENTION

It is an object of the present invention to provide a monetary card reading machine which can print an advertisement information on a receipt.

It is another object of the present invention to provide an advertisement information management system which can print an advertisement information on a receipt.

It is still another object of the present invention to provide a receipt printing method for a monetary card reading machine.

In order to achieve the above object, the present invention discloses a monetary card reading machine comprising a memory, a processor, and a print module, wherein the memory includes a software program and at least one advertisement information; the processor is electrically connected to the memory and can execute the software program; and the print module is electrically connected to the processor and prints at least one advertisement information on the receipt by executing the program.

In order to achieve another object, the present invention discloses an advertisement information management system comprising an information processing server and at least one monetary card reading machine. The information processing server comprises at least one advertisement information; the at least one monetary card reading machine is electrically connected to the information processing server, each one of the monetary card reading machines comprising a memory, a processor, and a print module, wherein the memory includes a software program; the processor is electrically connected to the memory, wherein the processor can execute the software program; and the print module is electrically connected to the processor and prints at least one advertisement information on the receipt by executing the program.

In order to achieve still another object, the present invention discloses a receipt printing method, comprising the steps of: obtaining at least one consumer information; selecting a target advertisement information from a plurality of advertisement informations according to the at least one consumer information; and printing the target advertisement information.

According to one of the embodiments of the present invention, the at least one consumer information comprises the monetary card information, the transaction time, the amount of payment, the commodity type, or the consumer's gender.

### BRIEF DESCRIPTION OF THE DRAWINGS

FIG. 1 illustrates a 3D view of a monetary card reading machine of the present invention;

FIG. 2 illustrates a structural view of a first embodiment of the monetary card reading machine of the present invention;

FIG. 3 illustrates a flow chart of a first embodiment of a receipt printing method of the present invention;

FIG. 4 illustrates a structural view of a second embodiment for the monetary card reading machine of the present invention;

FIG. 5 illustrates a flow chart of a second embodiment of a receipt printing method of the present invention;

FIG. 6 illustrates an embodiment of a case of using a designated printing time as the consumer information;

FIG. 7 illustrates an embodiment of a case of using a credit card issuer as the consumer information;

FIG. 8 illustrates an embodiment in a case of using an amount of payment as the consumer information;

FIG. 9 illustrates a structural view of an advertisement information management system of the present invention; and

FIG. 10 illustrates a flow chart of a third embodiment of a receipt printing method of the present invention.

### DETAILED DESCRIPTION OF THE PREFERRED EMBODIMENT

The advantages and innovative features of the invention will become more apparent from the following detailed description when taken in conjunction with the accompanying drawings.

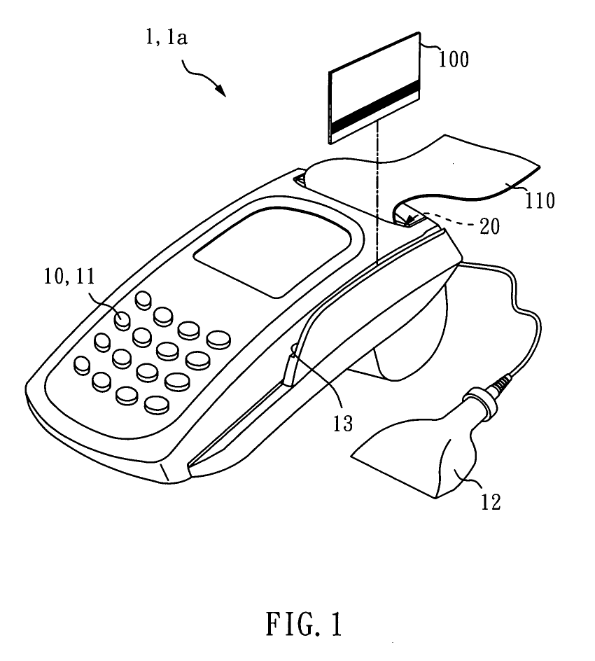

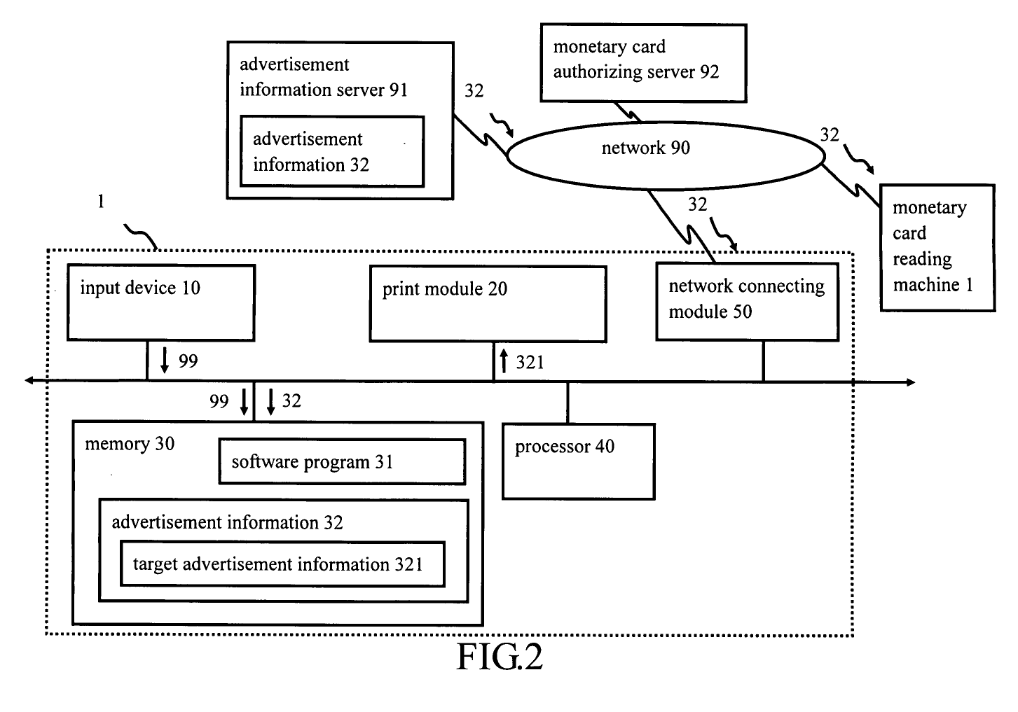

Please refer to both FIG. 1 and FIG. 2. FIG. 1 illustrates a 3D view of a monetary card reading machine in the present invention, while FIG. 2 illustrates a structural view of a first embodiment of the monetary card reading machine in the present invention.

In figures, the monetary card reading machine 1 comprises at least one input device 10, a print module 20, a memory 30, a processor 40, and a network connecting module 50. The processor 40 serves as a control center and is electrically coupled to the at least one input device 10, the print module 20, the memory 30, and the network connecting module 50. It is noted that the monetary card reading machine 1 reads monetary cards such as magnetic or chip-embedded credit cards, ATM cards, debit cards, etc.

The memory 30 includes a software program 31 and at least one advertisement information 32. When the memory 30 only stores one advertisement information 32, the print module 20 prints the advertisement information; when the memory 30 stores a plurality of advertisement informations 32, the processor 40 selects one advertisement information from the plurality of advertisement informations 32. The following is described based on the plurality of advertisement informations 32.

The processor 40 prints an advertisement information by executing the software program 31 in the memory 30. The plurality of advertisement informations 32 is printed in the form of text or graphics. The print module 20 can print an advertisement information 32 for consumers. It is noted that the monetary card reading machine 1 can use an externally connected print apparatus to print an advertisement information 32.

The network connecting module 50 is connected to network 90 (which is an intranet or external network) so as to obtain authorization or verification of the monetary card, and to retrieve an advertisement information 32 through the advertisement information server 91. When the monetary card 100 is a credit card, the monetary card authorizing server 92 is the server of the bank that issued the card and is implemented for authorizing the credit card transaction. It is noted that it is not necessary to connect to the monetary card authorizing server 92 for authorization or verification if the monetary card 100 (such as a bonus card) does not need to be authorized or verified.

The advertisement information server 91 can be an advertisement information distributing center (which is an external server connected to the Internet), or an internal server of a branch store (for handling advertisement informations, payments, commodities, etc.); the advertisement information sources of advertisement information server 91 are advertisement information suppliers who send advertisement informations through the network 90 to the advertisement information server 91. In addition, the advertisement information server 91 generally connects to a plurality of monetary card reading machines 1.

The plurality of advertisement informations 32 are transmitted from the advertisement information server 91 to the network connecting module 50, and then they are transmitted and stored in the memory 30. There are various ways for the advertisement information server 91 to transfer information with the monetary card reading machine 1; for example, the advertisement information server 91 can connect via the Internet, a dial-up connection, or a modem to the monetary card reading machine 1.

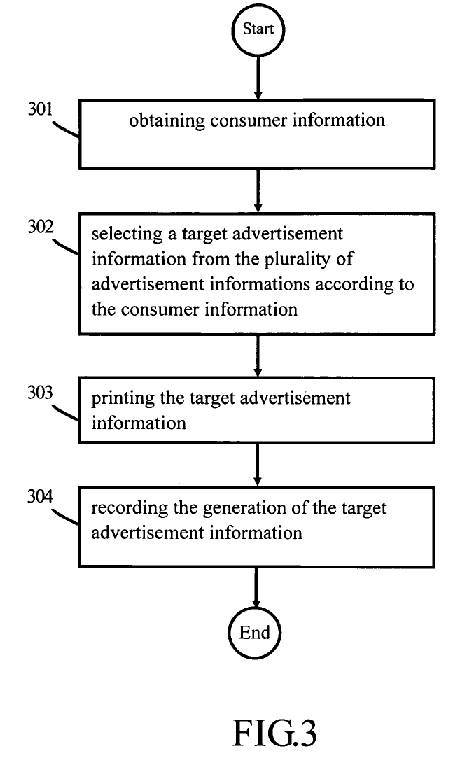

Please refer to FIG. 1 to FIG. 3 for a first embodiment of the receipt printing method in the present invention; these figures illustrate the operations of the monetary card reading machine 1. In this embodiment, a plurality of advertisement informations 32 is downloaded through the advertisement information server 91 and stored in the memory 30 of the monetary card reading machine 1. The plurality of advertisement informations 32 is downloaded by the monetary card reading machine 1 from the advertisement information server 91 can be, for example, one of several ways: automatically downloaded at a specific time (update once everyday), manually downloaded by the operator of the monetary card reading machine 1, or automatically downloaded by the monetary card reading machine 1 and then manually installed by the operator of the monetary card reading machine 1.

### Step 301: Obtaining Consumer Information 99.

The consumer information 99 is used for selecting the advertisement information to be printed on a receipt 110. The consumer information 99 is generated when the consumer uses the monetary card 100 to conduct a transaction. For example, the consumer information 99 can be the monetary card information (issuer, type of credit card, etc), a payment time, an amount of payment, a commodity type, or a consumer's gender. It is noted that the type of the consumer information 99 is not limited to those depicted above and that more than one consumer information can be obtained.

The monetary card reading machine 1 uses the input device 10 to obtain at least one consumer information 99. The input device 10 can comprise input buttons 11, a commodity ID reading device 12, and a card reading module 13. When the consumer uses the monetary card 100 to shop in a store, the cashier uses the card reading module 13 of the monetary card reading machine 1 to read the information stored in the monetary card 100. The monetary card reading machine 1 can read various kinds of monetary cards 100, such as credit cards, ATM cards, membership cards, bonus cards, electronic wallets, or commuter cards; therefore, the input device 10 has to use a specific card reading module 13 to read magnetic or chip-embedded cards.

The commodity ID reading device 12 can read a bar code embedded on the commodity to speed up the input process. The input buttons 11 are provided for the cashier to input a commodity ID or a price of a commodity.

It is noted that the number and the form of the input device 10 are not limited to those depicted above and can be adapted based on actual requirements.

Step 302: Selecting a Target Advertisement Information 321 from the Plurality of Advertisement Informations 32 According to the Consumer Information 99.

After the monetary card reading machine 1 obtains the consumer information 99 through the input device 10, it selects the target advertisement information 321 from the plurality of advertisement informations 32 according to the consumer information 99 by executing the software program 31. That is, the target advertisement information 321 is not randomly generated; instead, it is generated based on the consumer information 99.

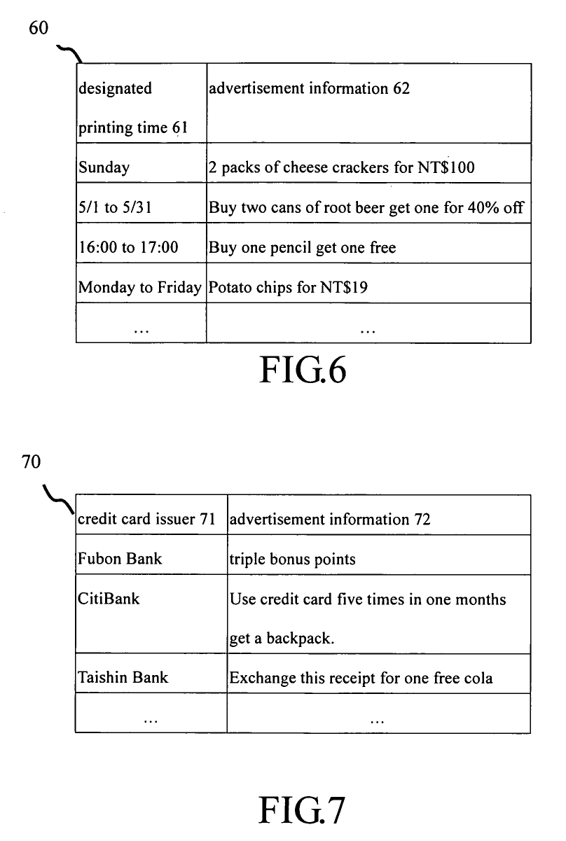

Please refer to FIG. 2 and FIG. 6, wherein FIG. 6 is an embodiment in which the consumer information 99 refers to a designated printing time. In this embodiment, each advertisement information 62 includes information of the designated printing time. A designated printing time database 60 is stored in the memory 30 and comprises a plurality of designated printing times 61 and a plurality of advertisement informations 62, wherein the designated printing times 61 correspond to respective advertisement informations 62. For example, when the designated printing time 61 refers to “Monday to Friday” and the corresponding advertisement information 62 is “Potato chips for NT$ 19,” that means the advertisement information supplier asks that the “Potato chips for NT$ 19” advertisement information be printed from Monday to Friday.

Please refer to FIG. 2 and FIG. 7, wherein FIG. 7 is an embodiment in which the consumer information 99 refers to a credit card issuer. In this embodiment, each advertisement information 72 includes information about a certain credit card issuer. A credit card issuer database 70 is stored in the memory 30 and comprises a plurality of credit card issuers 71 and a plurality of advertisement informations 72, wherein the credit card issuers 71 correspond to respective advertisement informations 72. For example, when a consumer uses a credit card issued by Fubon Bank and a cashier uses the card reading module 13 to discover the credit card issuer 71 is Fubon Bank, then the consumer information 99 refers to the credit card issuer 71, and the target advertisement information 321 is “triple bonus points,” corresponding to Fubon Bank in the plurality of advertisement informations 72, to encourage shopping by the card holder.

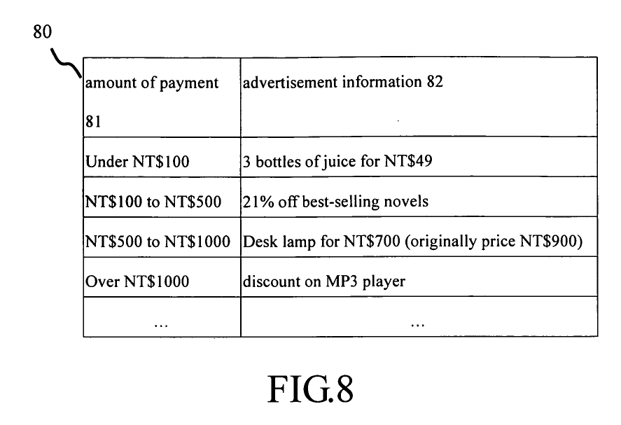

Please refer to FIG. 2 and FIG. 8, wherein FIG. 8 is an embodiment in which the consumer information 99 refers to the amount of payment. In this embodiment, each advertisement information 82 includes information on an amount of payment. A payment database 80 is stored in the memory 30 and comprises a plurality of amounts of payment 81 and a plurality of advertisement informations 82, wherein the plurality of amounts of payment 81 correspond to respective advertisement informations 82. For example, when the consumer uses the monetary card 100 to pay for the commodity and the cashier uses the input buttons 11 to input the amount of payment as “over NT$ 1000”, the consumer information 99 refers to the amount of payment 81, and the target advertisement information 321 is “discount on MP3 player,” which corresponds to “over NT$ 1000” in the plurality of advertisement informations 82 to encourage shopping by the card holder.

If multiple advertisement informations 32 correspond to the consumer information 99, one of the advertisement informations can be selected as the target advertisement information 321 via sequencing or random selection.

The target advertisement information 321 is printed by the print module 20 of the monetary card reading machine 1, wherein the target advertisement information 321 is printed in the form of text or graphics. In addition, the target advertisement information 321 outputted by the print module 20 further comprises a bar code (such as special price bar code, promotion bar code, etc), wherein the bar code corresponds to text or a graphic. For example, if the text or graphic printed on the receipt 110 is information on a special price commodity, the bar code can be the commodity ID bar code of that special price commodity. When a customer uses the receipt 110 printed with the special price commodity information to buy that special price commodity, the cashier needs only to use the commodity ID reading device 12 to read the bar code.

From the above, because the target advertisement information 321 is selected based on consuming habits of a certain consumer, it should provide better advertising effects.

### Step 303: Printing the Target Advertisement Information 321.

The print module 20 prints the target advertisement information 321 on the receipt, wherein the target advertisement information 321 is printed in the form of text or a graphic.

### Step 304: Recording the Generation of the Target Advertisement Information 321.

The generation of the target advertisement information 321 is recorded. For example, the monetary card reading machine 1 records the number of times the advertisement information is printed and the printing times for a certain advertisement information supplier so that the advertisement information supplier can be charged based on the record.

After the target advertisement information 321 is generated, it is possible to transmit the advertisement information printing record to the advertisement information server 91 manually by the user (for example the user presses a function key on the monetary card reading machine 1), or automatically at a certain time of a day. The monetary card reading machine 1 can store all the advertisement information printing records for use in all kinds of reports.

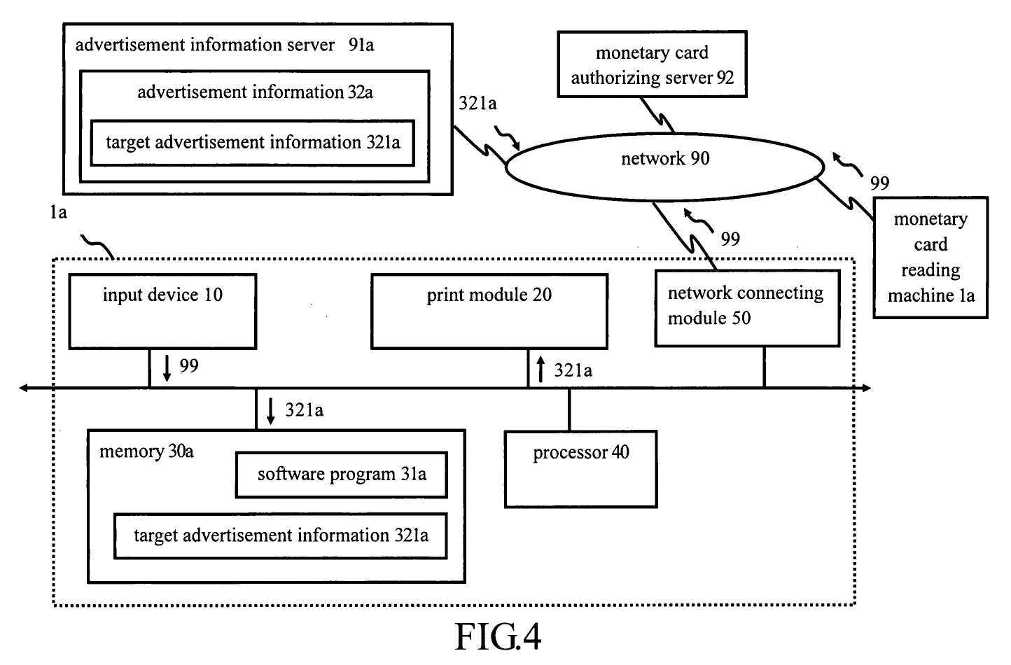

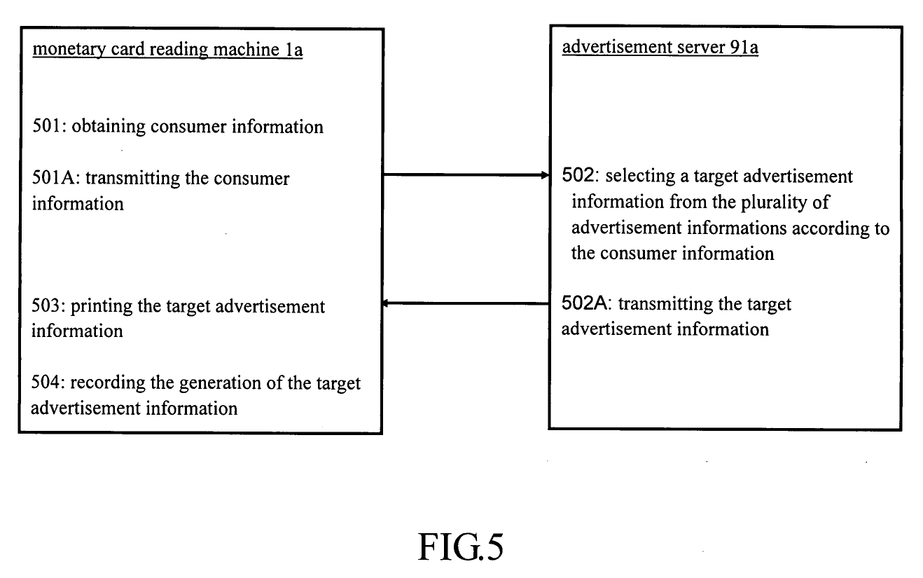

Please refer to FIG. 4 and FIG. 5, wherein FIG. 4 illustrates a structure view of a second embodiment for the monetary card reading machine in the present invention; FIG. 5 illustrates a flow chart of a second embodiment of a receipt printing method in the present invention.

What is different from the first embodiment is that the memory 30a of the monetary card reading machine 1a only (or temporarily) stores the required target advertisement information 321a, not all the advertisement informations 32a. Therefore, the target advertisement information is selected by the advertisement information server 91a. The following describes how the monetary card reading machine 1b operates:

### Step 501: Obtaining Consumer Information 99.

The monetary card reading machine 1a obtains the consumer information 99.

Step 501 is the same as Step 301.

### Step 501A: Transmitting the Consumer Information 99.

The monetary card reading machine 1a transmits the consumer information 99 to advertisement information server 91a.

Step 502: Selecting a Target Advertisement Information 321a from the Plurality of Advertisement Informations 32a According to the Consumer Information 99.

The advertisement information server 91 a selects the target advertisement information 321a from the plurality of advertisement informations 32a according to the consumer information 99 and transmits the target advertisement information 321a to the network connecting module 50, and then the network connecting module 50 transmits the target advertisement information 321a to the memory 32a and stores it therein. What is different from the first embodiment is that the plurality of advertisement informations 32a (Please refer to embodiments from FIG. 6 to FIG. 8) are stored in the advertisement information server 91a only, and the target advertisement information 321a is selected from the advertisement information server 91a.

### Step 502A: Transmitting the Target Advertisement Information 321a.

The target advertisement information 321a selected by the advertisement information server 91a is transmitted to the memory 30a of the monetary card reading machine 1a.

### Step 503: Printing the Target Advertisement Information 321a.

The print module 20 prints the target advertisement information 321a on the receipt 110. The printed target advertisement information 321a can be a text only, a graphic only, or a text/graphic message.

### Step 504: Recording the Generation of the Target Advertisement Information 321a.

The generation of the target advertisement information 321a is recorded. Step 504 is the same as Step 304.

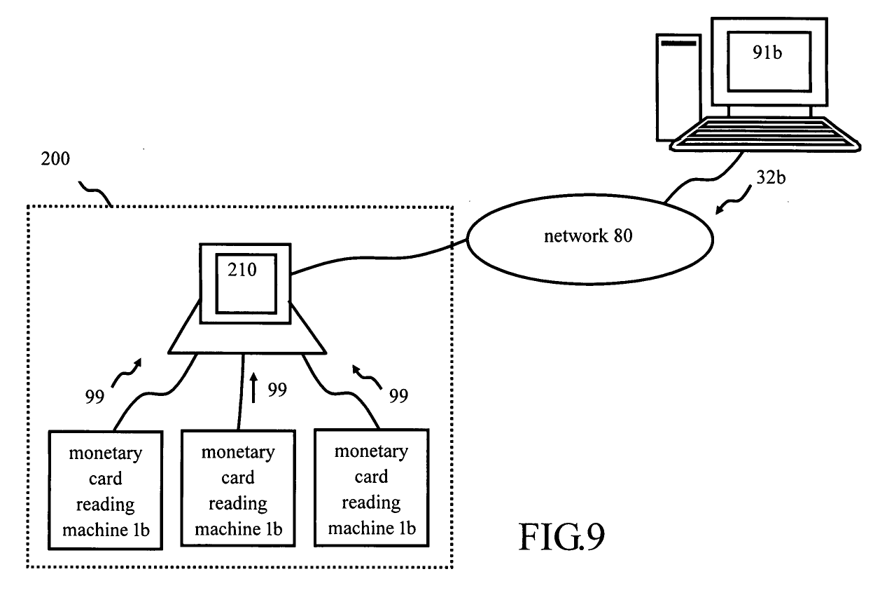

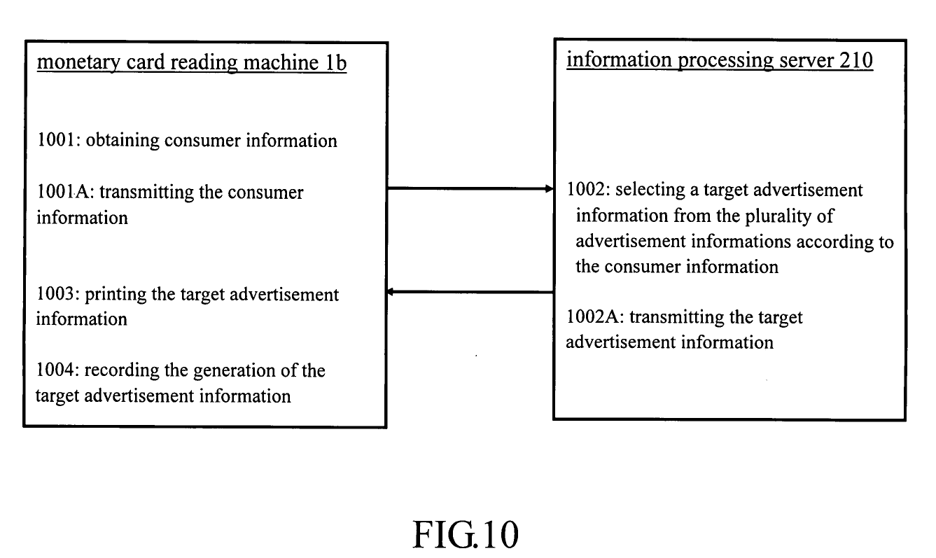

Please refer to both FIG. 9 and FIG. 10, wherein FIG. 9 illustrates a structural view of an advertisement information management system in the present invention; FIG. 10 illustrates a flow chart of a third embodiment of a receipt printing method in the present invention. The advertisement information management system 200 can print advertisement informations on the receipt 110 for the consumer; the advertisement information management system 200 includes an information processing server 210 and at least one monetary card reading machine 1b.

The major difference of the third embodiment from the previous embodiments is that the information processing server 210 is responsible for storing and selecting the advertisement information; the monetary card reading machine 1b only receives the advertisement information to be printed from the information processing server 210. The information processing server 210 can be a server in a shopping mall for managing the data sent by the monetary card reading machine 1b and for communicating with the advertisement information server 91b bi-directionally. For example, the information processing server 210 can download the advertisement information 32b from the advertisement information server 91b, and the information processing server 210 can gather advertisement information printing records from every monetary card reading machine 1b and transmit them to the advertisement information server 91b. It is noted that the advertisement information 32b can be stored in each one of the monetary card reading machines 1b of the advertisement information management system 200 and selected by the monetary card reading machine 1b.

The following steps describe how the advertisement information management system operates:

### Step 1001: Obtaining Consumer Information 99.

The monetary card reading machine 1b obtains the consumer information 99.

### Step 1001A: Transmitting the Consumer Information 99.

The consumer information 99 is transmitted by the monetary card reading machine 1b to the information processing server 210.

Step 1002: Selecting a Target Advertisement Information 321a from the Plurality of Advertisement Informations 32b According to the Consumer Information 99.

The information processing server 210 selects a target advertisement information 321a from the plurality of advertisement informations 32b according to the consumer information 99.

### Step 1002A: Transmitting the Target Advertisement Information.

The target advertisement information is transmitted by the information processing server 210 to the monetary card reading machine 1b.

### Step 1003: Printing the Target Advertisement Information.

The monetary card reading machine 1b prints the target advertisement information.

### Step 1004: Recording the Generation of the Target Advertisement Information.

The monetary card reading machine 1b records the generation of the target advertisement information.

It is noted that the above-mentioned embodiments are only for illustration; it is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A monetary card reading machine capable of printing an advertisement on a receipt, the monetary card reading machine comprising:
a memory, the memory including a software program and at least one advertisement information;
a processor electrically connected to the memory, wherein the processor can execute the software program; and
a print module electrically connected to the processor, the print module printing the at least one advertisement information on the receipt by executing the program.

2. The monetary card reading machine as claimed in claim 1, wherein the at least one advertisement information has more than one advertisement information, the monetary card reading machine further comprising:
at least one input device electrically connected to the processor; the at least one input device can obtain at least one consumer information, wherein the at least one advertisement information printed on the receipt is determined by the at least one consumer information.

3. The monetary card reading machine as claimed in claim 2, wherein the at least one consumer information comprises monetary card information, a transaction time, an amount of payment, a commodity type, or a consumer's gender.

4. The monetary card reading machine as claimed in claim 2, wherein the at least one advertisement information printed by the print module comprises a text or a graphic.

5. The monetary card reading machine as claimed in claim 4, wherein the at least one advertisement information printed by the print module further comprises a bar code which corresponds to the text or the graphic.

6. The monetary card reading machine as claimed in claim 4, wherein the input device comprises a plurality of input buttons, a card reading module or a commodity ID reading device.

7. An advertisement information management system capable of printing an advertisement on a receipt, the advertisement information management system comprising:
an information processing server comprising at least one advertisement information;
at least one monetary card reading machine electrically connected to the information processing server, each of the monetary card reading machines comprising:
a memory, the memory including a software program;
a processor electrically connected to the memory, wherein the processor can execute the software program; and
a print module electrically connected to the processor, the print module printing the at least one advertisement information on the receipt by executing the program.

8. The advertisement information management system as claimed in claim 7, wherein the at least one advertisement information has more than one advertisement information, the monetary card reading machine further comprising:
at least one input device electrically connected to the processor; the at least one input device can obtain at least one consumer information;
a network connecting module electrically connected to the processor, the network connecting module being provided for transmitting the consumer information to the information processing server, the information processing server using the at least one consumer information to determine the at least one advertisement information printed on the receipt and to transmit it to the network connecting module.

9. The advertisement information management system as claimed in claim 8, wherein the at least one consumer information comprises monetary card information, a transaction time, an amount of payment, a commodity type, or a consumer's gender.

10. The advertisement information management system as claimed in claim 8, wherein the at least one advertisement information printed by the print module comprises a text or a graphic.

11. The advertisement information management system as claimed in claim 10, wherein the at least one advertisement information printed by the print module further comprises a bar code which corresponds to the text or the graphic.

12. The advertisement information management system as claimed in claim 10, wherein the input device comprises a plurality of input buttons, a card reading module, or a commodity ID reading device.

13. A receipt printing method for using with a monetary card reading machine, the method comprising the steps of:
obtaining at least one consumer information;
selecting a target advertisement information from a plurality of advertisement informations according to the at least one consumer information; and
printing the target advertisement information.

14. The method as claimed in claim 13, the method further comprising the step of:
recording the generation of the target advertisement information.

15. The method as claimed in claim 13, wherein the at least one consumer information comprises monetary card information, a transaction time, an amount of payment, a commodity type, or a consumer's gender.
